(19) United States
(12) Patent Application Publication
(10) Pub. No.: US 2018/0170714 A1
(43) Pub. Date: Jun. 21, 2018

(54) DEVICE AND METHOD FOR CONTROLLING ELEVATOR CAR MOVEMENT INTO A TRANSFER SPACE ASSOCIATED WITH MULTIPLE VERTICAL PATHWAYS

(71) Applicant: OTIS ELEVATOR COMPANY, Farmington, CT (US)

(72) Inventors: Tadeusz Pawel Witczak, Farmington, CT (US); Richard J. Ericson, Southington, CT (US); Richard N. Fargo, Plainville, CT (US); Enrico Manes, Feeding Hills, MA (US); Bruce P. Swaybill, Farmington, CT (US)

(21) Appl. No.: 15/381,754

(22) Filed: Dec. 16, 2016

(51) Int. Cl. B66B 9/00; B66B 1/28

(52) U.S. Cl. CPC B66B 9/003; B66B 2201/30; B66B 1/28

(57) ABSTRACT

An illustrative example elevator system includes a first vertical pathway, a second vertical pathway, and a transfer space situated to allow movement between the vertical pathways. An elevator car is selectively moveable along the respective vertical pathways and through the transfer space. At least one blocker has a passage condition and a blocking condition. The passage condition allows the elevator car to move from one of the vertical pathways into the transfer space when the transfer space is configured to receive the elevator car from the one of the vertical pathways. The blocking condition prevents the elevator car from moving from the one of the vertical pathways into the transfer space when the transfer space is not configured to receive the elevator car from the one of the vertical pathways.

### BACKGROUND

There are a variety of elevator system configurations. Many elevator systems include a single car that is situated for movement within a single hoistway. Traction-based and hydraulic machines typically cause movement of the car between landings to provide elevator service based on passenger requests. Such systems are useful for many situations but there are different building and tenant considerations that have prompted elevator system designers to develop other types of systems.

One proposed elevator system configuration includes multiple hoistways or vertical pathways and a transfer floor or transfer space that allows an elevator car to transition from one of the pathways to another. When multiple cars and multiple vertical pathways are used, a variety of scheduling strategies become possible to provide various types of elevator service to address differing needs under different circumstances.

One of the challenges associated with such elevator systems is that they introduce new challenges requiring control over movement of the elevator cars within the various portions of the elevator system.

### SUMMARY

An illustrative example elevator system includes a first vertical pathway, a second vertical pathway, and a transfer space situated to allow movement between the respective vertical pathways. An elevator car is selectively moveable along the respective vertical pathways and through the transfer space. At least one blocker has a passage condition and a blocking condition. The passage condition allows the elevator car to move from one of the vertical pathways into the transfer space when the transfer space is configured to receive the elevator car from the one of the vertical pathways. The blocking condition prevents the elevator car from moving from the one of the vertical pathways into the transfer space when the transfer space is not configured to receive the elevator car from the one of the vertical pathways.

In an example embodiment having one or more features of the elevator system of the previous paragraph, the at least one blocker comprises at least one first blocker at least partially in the first vertical pathway near the transfer space and at least one second blocker at least partially in the second vertical pathway near the transfer space.

In an example embodiment having one or more features of the elevator system of either of the previous paragraphs, the at least one first blocker is situated above the transfer space to selectively prevent the elevator car from descending from the first vertical pathway into the transfer space and the at least one second blocker is situated above the transfer space to selectively prevent the elevator car from descending from the second vertical pathway into the transfer space.

In an example embodiment having one or more features of the elevator system of any of the previous paragraphs, the at least one blocker is situated in the transfer space.

In an example embodiment having one or more features of the elevator system of any of the previous paragraphs, the at least one blocker is situated on the elevator car.

An example embodiment having one or more features of the elevator system of any of the previous paragraphs includes a control associated with the at least one blocker, the control being configured to cause the at least one blocker to be in the passage condition based on the control determining that the transfer space is configured to receive the elevator car from the one of the vertical pathways, the control otherwise causing the at least one blocker to be in the blocking condition.

An example embodiment having one or more features of the elevator system of any of the previous paragraphs includes a carriage in the transfer space, the carriage being configured to receive the elevator car and to effect horizontal movement of the elevator car within the transfer space. The control determines that the transfer space is configured to receive the elevator car from the first vertical pathway when the carriage is aligned with the first vertical pathway and the control determines that the transfer space is configured to receive the elevator car from the second vertical pathway when the carriage is aligned with the second vertical pathway.

An example embodiment having one or more features of the elevator system of any of the previous paragraphs includes at least one detector that provides an indication of whether the carriage is aligned with one of the vertical pathways. The control determines whether the at least one blocker should be in the blocking or passage condition based on the indication from the at least one detector.

In an example embodiment having one or more features of the elevator system of any of the previous paragraphs, the control is configured to cause the carriage to move within the transfer space.

An example embodiment having one or more features of the elevator system of any of the previous paragraphs includes a carriage in the transfer space, the carriage being configured to receive the elevator car and to effect horizontal movement of the elevator car within the transfer space. The carriage is horizontally moveable in the transfer space between a first position aligned with the first vertical pathway and a second position aligned with the second vertical pathway. The transfer space is configured to receive the elevator car from the first vertical pathway when the carriage is in the first position and the transfer space is configured to receive the elevator car from the second vertical pathway when the carriage is in the second position.

In an example embodiment having one or more features of the elevator system of any of the previous paragraphs, the carriage includes guiding surfaces to guide movement of the elevator car onto the carriage in the transfer space. Each of the vertical pathways has guiding surfaces to guide movement of the elevator car. The carriage is in the first position when the carriage guiding surfaces are aligned with the guiding surfaces in the first vertical pathway and the carriage is in the second position when the carriage guiding surfaces are aligned with the guiding surfaces in the second vertical pathway.

In an example embodiment having one or more features of the elevator system of any of the previous paragraphs, the carriage interacts with the at least one blocker to cause the at least one blocker to move between the blocking and passage positions.

In an example embodiment having one or more features of the elevator system of any of the previous paragraphs, the at least one blocker comprises a bumper configured to cushion any impact of the elevator car against the at least one blocker.

An illustrative example method of controlling movement of an elevator car is useful in an elevator system that includes a plurality of vertical pathways and a horizontally oriented transfer space. The method includes moving the elevator car within one of the vertical pathways toward the transfer space and controlling at least one blocker to be in a passage condition allowing the elevator car to move from the one of the vertical pathways into the transfer space when the transfer space is configured to receive the elevator car from the one of the vertical pathways, or in a blocking condition preventing the elevator car from moving from the one of the vertical pathways into the transfer space when the transfer space is not configured to receive the elevator car from the one of the vertical pathways.

In an example embodiment having one or more features of the method of the previous paragraph the at least one blocker is at least one of situated in the one of the vertical pathways near the transfer space, situated in the transfer space, and situated on the elevator car.

In an example embodiment having one or more features of the method of either of the previous paragraphs, the elevator system includes a carriage configured to receive the elevator car and to effect horizontal movement of the elevator car within the transfer space. The method comprises selectively moving the carriage horizontally in the transfer space between a first position for receiving the elevator car from the first one of the vertical pathways and a second position for receiving the elevator car from a second one of the vertical pathways.

In an example embodiment having one or more features of the method of any of the previous paragraphs, the carriage includes guiding surfaces to guide movement of the elevator car onto the carriage in the transfer space, each of the vertical pathways has guiding surfaces to guide movement of the elevator car, the carriage is in the first position when the carriage guiding surfaces are aligned with the guiding surfaces in the first one of the vertical pathways, and the carriage is in the second position when the carriage guiding surfaces are aligned with the guiding surfaces in the second one of the vertical pathways.

In an example embodiment having one or more features of the method of any of the previous paragraphs, the method includes using the carriage to cause the at least one blocker to move between the blocking and passage positions.

In an example embodiment having one or more features of the method of any of the previous paragraphs, the method includes detecting a position of the carriage in the transfer space and controlling the at least one blocker based on the detected position of the carriage.

In an example embodiment having one or more features of the method of any of the previous paragraphs, the method includes using a control to cause the at least one blocker to be in the passage condition with respect to the one of the vertical pathways based on the control determining that the transfer space is configured to receive the elevator car from the one of the vertical pathways, and otherwise using the control to cause the at least one blocker to be in the blocking condition with respect to the one of the vertical pathways.

Various features and advantages of at least one disclosed embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an elevator system designed according to an embodiment of this invention.

FIG. 2 is an elevational view of the embodiment of FIG. 1 taken along the lines 2-2 in FIG. 1.

FIG. 3 schematically illustrates another example elevator system embodiment.

FIG. 4 schematically illustrates another example elevator system embodiment.

### DETAILED DESCRIPTION

Embodiments of this invention provide improvements in control over movement of an elevator car from a vertical pathway into a transfer space that allows an elevator car to transition between vertical pathways. Embodiments of this invention include at least one blocker that selectively prevents movement of an elevator car into the transfer space when the transfer space is not configured to receive an elevator car from the vertical pathway where the elevator car is currently located.

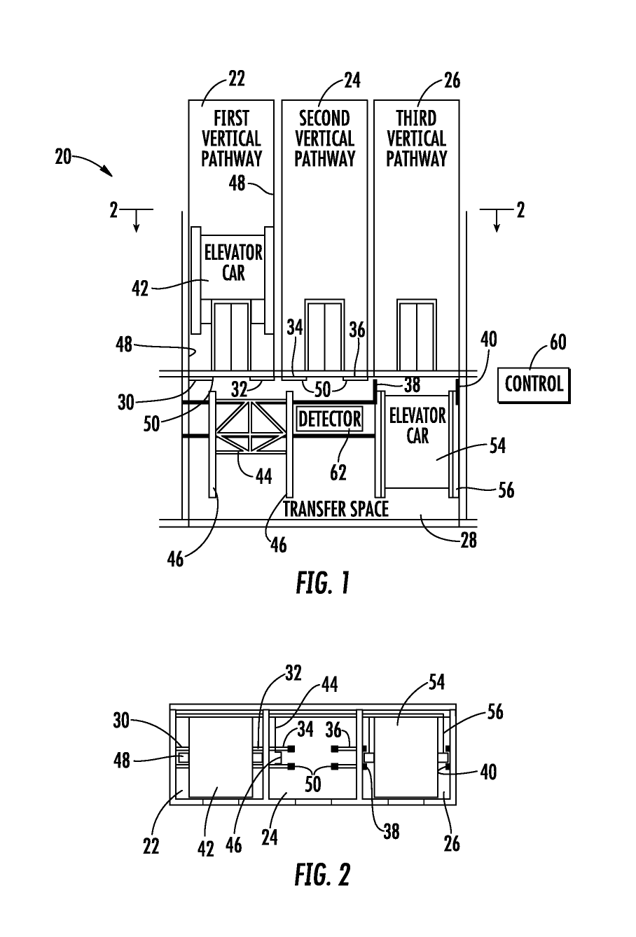

FIG. 1 schematically illustrates selected portions of an elevator system 20 that includes a plurality of vertical pathways. In the illustration, a first vertical pathway 22, second vertical pathway 24 and third vertical pathway 26 are each configured to receive an elevator car such that the elevator car is moveable along the pathway for providing elevator service, for example. Three vertical pathways are illustrated for discussion purposes. Other numbers of vertical pathways and various numbers of elevator cars may be used to meet the needs of a particular installation.

A transfer space 28 that allows movement between the vertical pathways is situated below at least a portion of the vertical pathways. Although the illustration of FIG. 1 shows the transfer space 28 effectively at the bottom of the vertical pathways, the transfer space 28 may be located at a variety of vertical locations within the elevator system 20. Additionally, only one transfer space 28 is illustrated for discussion purposes. Some embodiments will include multiple transfer spaces associated with the plurality of vertical pathways.

The illustrated transfer space 28 is arranged essentially horizontal but in some embodiments the transfer space will have a generally inclined (or declined) orientation relative to the vertical pathways. Those skilled in the art who have the benefit of this description will be able to configure the transfer space to be compatible with their particular arrangement of vertical pathways.

At least one blocker is selectively controllable to be in a passage condition or a blocking condition. In the example embodiment shown in FIG. 1, there are a plurality of blockers associated with each of the vertical pathways. First blocker members 30 and 32 are situated in the transfer space 28 adjacent the first vertical pathway 22. Second blocker members 34 and 36 are associated with the second vertical pathway 24. Third blocker members 38 and 40 are associated with the third vertical pathway 26. When the blocker members are in the passage condition, they allow an elevator car to move from the corresponding vertical pathway into the transfer space. When the blocker members are in the blocking condition, they prevent an elevator car from moving from the corresponding vertical pathway into the transfer space.

The blocker members are structurally capable of supporting the elevator car or at least resisting downward movement of the elevator car when the blockers are in the blocking condition. Example blocker members comprise metal beams or rods that are moveable between positions corresponding to the blocking and passage conditions.

A carriage 44 is situated within the transfer space 28 to move horizontally to receive an elevator car and facilitate horizontal movement of the elevator car within the transfer space 28. The configuration of the carriage 44 and the mechanism for moving the carriage 44 within the transfer space 28 may vary to meet the particular needs of a given installation. Those skilled in the art who have the benefit of this description will realize how to select or design a carriage and carriage moving mechanism to meet their particular needs.

The scenario schematically shown in FIG. 1 includes an elevator car 42 in the first vertical pathway 22 descending toward the transfer space 28. The first blocker members 30 and 32 are in the blocking position to prevent the elevator car 42 from entering the transfer space 28 because the transfer space 28 is not currently configured to receive the elevator car 42. In the illustrated scenario, the carriage 44 within the transfer space 28 is not properly positioned to receive the elevator car 42 from the first vertical pathway 22.

In this example, when the carriage 44 is situated relative to a vertical pathway so that guiding surfaces 46 on the carriage 44 are aligned with guiding surfaces 48 of the vertical pathway, the transfer space 28 is configured to receive an elevator car from the corresponding vertical pathway. In FIG. 1, if the carriage 44 were moved further to the left (according to the drawing) and aligned with the first vertical pathway 22, the elevator car 42 may follow the guiding surfaces 48 onto the guiding surfaces 46 of the carriage 44 for controlled transfer of the elevator car 42 from the first vertical pathway into the transfer space 28. Depending on the needs of a particular situation, the elevator car 42 may be transferred over for movement along the second vertical pathway 24, for example, as the carriage 44 translates or moves along the transfer space 28 into alignment with the second vertical pathway 24.

Although no elevator car is shown in the second vertical pathway in the condition illustrated in FIG. 1, the second blocker members 34 and 36 are in the blocking condition because the carriage 44, for example, is not aligned with the second vertical pathway 24 for receiving an elevator car from that pathway.

The example of FIG. 1 includes a second elevator car 54 supported on a carriage 56 that is aligned with the third vertical pathway 26. The third blocker members 38 and 40 are in the passage condition to allow transfer of the elevator car 54 between the third vertical pathway 26 and the carriage 56. As can be appreciated from FIGS. 1 and 2, the first and second blocker members 30-36 are in the blocking condition and extend into the pathway of an elevator car within the first or second vertical pathways 22, 24. The third blocker members 38 and 40, on the other hand, are situated so that they do not extend into or interfere with the vertical movement of the elevator car 54 allowing that elevator car to transition between the transfer space 28 and the third vertical pathway 26.

The example blocker members include a buffer 50 that is configured to cushion or at least partially absorb forces associated with any impact between an elevator car and the blocker members. In some examples, the buffer 50, which is schematically represented in the drawing, includes at least one resilient component such as coil springs, gas springs, compressible material, or a combination of these. The buffer 50 in some embodiments operates to reduce a speed of movement of the elevator car 54. The buffer 50 in some examples resembles a buffer used in other locations in known elevator systems, such as a buffer situated in a pit at the bottom of a hoistway. The buffer 50 may be supported on the blocker member or the blocker member may be supported on the buffer 50 at least when the blocker member is in the blocking position.

The blocker members 30-40 in some examples are supported in a way that allows transfer of a vertical load on the blocker members to a pit floor beneath the vertical pathways and transfer space. For example, a compressive member extends to the pit floor to transfer loads directly to the floor in some embodiments.

In other embodiments the way in which the blocker members are supported by the walls of the vertical pathways or by the structure of the transfer space is configured to support the load of a fully loaded car resting on the blocker members.

The example of FIG. 1 includes a control 60 that controls the positions or conditions of the blocker members 30-40. The control 60 determines the position of the carriages 44 and 56, respectively, to determine which of the blocker members, if any, can be in the passage condition. In this example, the control 60 is programmed to keep the blocker members in the blocking condition as a default and only to allow a blocking member to move into the passage condition when the transfer space 28 is configured to receive an elevator car from a corresponding one of the vertical pathways. For example, the control 60 determines whether one of the carriages is in a first position properly aligned with the first vertical pathway to allow transfer of an elevator car between that vertical pathway and the transfer space 28. The control 60 in this example controls the second blocker members 34 and 36 to be in the passage condition when one of the carriages 44 or 56 is properly aligned with the second vertical pathway 24. The control 60 similarly controls the third blocker members 38 and 40 when a carriage is properly aligned with the third vertical pathway 26.

FIG. 1 includes a detector 62 associated with the transfer space 28 in a manner to provide an indication of a detected position of at least one of the carriages 44 and 56. The detector 62 in this example provides information to the control 60 allowing the control 60 to determine the respective locations of the carriages 44 and 56 and to control the respective blocker members based on the indication from the detector 62. Given this description, those skilled in the art will realize that a variety of detector configurations and arrangements would be useful for providing information regarding the configuration of the transfer space 28 for purposes of appropriately controlling at least one blocker.

Other embodiments have blocker members situated for physical interaction with at least one of the carriages so that the physical presence of the carriage aligned properly with a vertical pathway causes the corresponding blocker members to move into the passage condition. Movement of the carriage out of alignment results in the blocker members moving into the blocking position. In one embodiment, the blocker members may be activated by a dedicated activation means including, for example, hydraulics, pneumatics, magnets, or motors.

In some embodiments, when a carriage is situated to receive an elevator car from a vertical pathway, the corresponding blocker members include a portion that maintains the carriage in that position until the elevator car is properly received by the carriage. In other embodiments the blocker members are mechanically linked with a structural member that holds the carriage in position to receive the elevator car. Once the car is properly received, the carriage is able to move in the transfer space and the corresponding blocker members move back into the blocking position.

Some embodiments include additional speed control over an elevator car moving toward one of the blocker members in a blocking condition. For example, the control 60 determines when an elevator car is approaching a blocking member in the blocking condition and activates a brake associated with that elevator car to at least slow down the elevator car before it reaches the blocking member. In some embodiments, the blocking members have associated structure situated to trigger a safety brake on the elevator car as the car approaches the blocking member.

The control 60 in some embodiments controls elevator car movement based on the positions or conditions of the various blocker members. For example, if a blocker member in the intended path of an elevator car fails to move into the passage condition when it otherwise should have, the control 60 prevents further movement of the elevator car in that direction until some corrective action is taken.

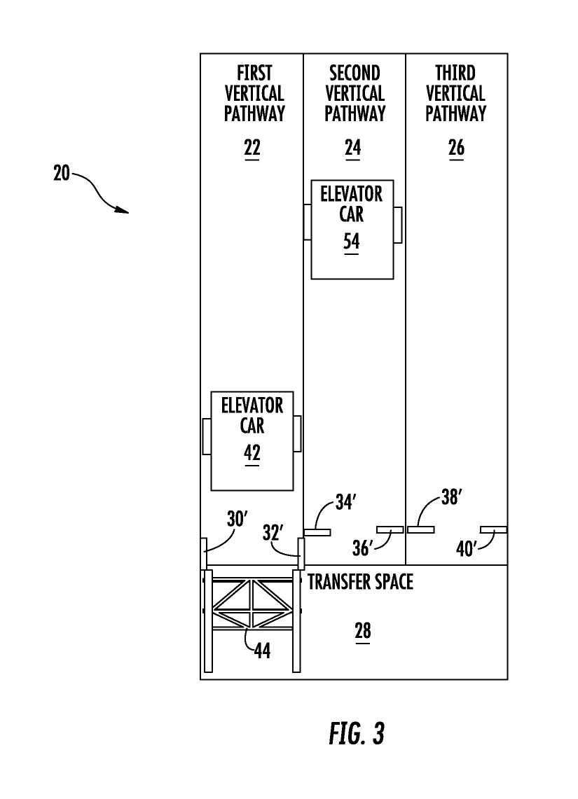

FIG. 3 schematically illustrates another example embodiment in which the blocker members are situated within the vertical pathways instead of being situated within the transfer space 28 like those in the example of FIG. 1. In the example of FIG. 3, first blocker members 30′ and 32′ are situated within the first vertical pathway 22 at a vertical position above and near the transfer space 28. Second blocker members 34′ and 36′ are situated within the second vertical pathway 24. Third blocker members 38′ and 40′ are situated within the third vertical pathway 26. The manner in which the blocker members 30′-40′ of FIG. 3 are controlled is the same as that described above regarding the embodiment of FIG. 1.

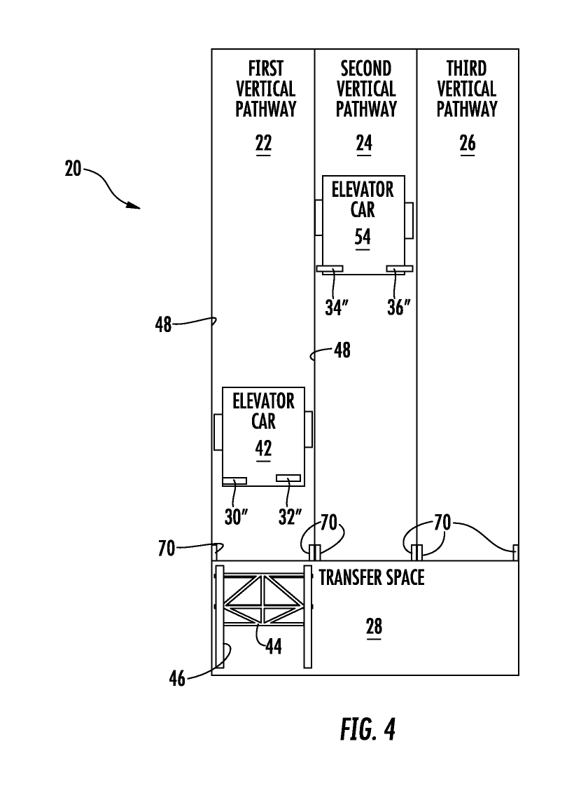

FIG. 4 schematically illustrates another example embodiment in which the blocker members are supported on the elevator cars. In this example, first blocker members 30″ and 32″, are situated on the elevator car 42. Second blocker members 34″ and 36″ are situated on the elevator car 54. Stoppers 70 are situated and configured to allow an elevator car to pass the stoppers 70. The blocker members on an elevator car, however, will contact the stoppers 70 when the blocker members are in the blocking condition. The blocker members in the example of FIG. 4 have a default position corresponding to the blocking condition and are controlled to stay in the passage condition when elevator car movement is desired. In another similarly constructed embodiment, the default position is the passage condition and control over elevator car movement is used to ensure that movement between a vertical pathway and the transfer space only occurs under desired conditions.

In one embodiment, the blocker members may be configured to trigger the safety brakes on the elevator car by, for example, contacting an actuating button or lever of the safety brakes. Thus, rather than physically stopping the elevator car, themselves, the blocker members permit the safety brakes to do so, potentially providing a smoother stop.

As shown in FIG. 4, for example, the second blocker members 34″ and 36″ on the elevator car 54 are in the blocking condition. The transfer space 28 is not illustrated in a condition that is configured to receive the elevator car 54 from the second vertical pathway 24 because no carriage is situated beneath that vertical pathway. With the blocker members 34″ and 36″ in the illustrated position, they would contact the stoppers 70 associated with the second vertical pathway 24 in a manner that prevents the elevator car 54 from descending into the transfer space 28.

The blocker members 30″ and 32″ on the elevator car 42 are in the passage condition where they will not contact or otherwise interact with the stoppers 70 to allow the elevator car 42 to pass between the first vertical pathway 22 and the transfer space 28 because the carriage 44 is properly situated for receiving the elevator car 42. In this example, the blocker members 30″ and 32″ retract toward the center of the elevator car to avoid contact or interaction with the stoppers 70 when the blocker members are in the passage condition.

In some of the example embodiments, the blocker members have a default position corresponding to the passage condition while in others the default position is the blocking position.

The various features and operations of the disclosed embodiments are not exclusive to the embodiments as discussed. Combinations of those features may be used in other embodiments and one or more features may be eliminated from a disclosed example to realize a different embodiment.

Various configurations of blocker members may be used in an embodiment of this invention for selectively controlling whether an elevator car is allowed to move between a vertical pathway and a horizontally oriented transfer space. The illustrated example embodiments demonstrate how an embodiment of this invention provides control over the position and movement of elevator cars within elevator systems that include multiple vertical pathways along which each car can move.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator system, comprising:
a first vertical pathway;
a second vertical pathway;
a transfer space situated to allow movement between the respective vertical pathways;
an elevator car that is selectively moveable along the respective vertical pathways, the elevator car being moveable through the transfer space;
at least one blocker that has a passage condition and a blocking condition, the passage condition allowing the elevator car to move from one of the vertical pathways into the transfer space when the transfer space is configured to receive the elevator car from the one of the vertical pathways, the blocking condition preventing the elevator car from moving from the one of the vertical pathways into the transfer space when the transfer space is not configured to receive the elevator car from the one of the vertical pathways.

2. The elevator system of claim 1, wherein the at least one blocker comprises
at least one first blocker at least partially in the first vertical pathway near the transfer space;
at least one second blocker at least partially in the second vertical pathway near the transfer space.

3. The elevator system of claim 2, wherein
the at least one first blocker is situated above the transfer space to selectively prevent the elevator car from descending from the first vertical pathway into the transfer space; and
the at least one second blocker is situated above the transfer space to selectively prevent the elevator car from descending from the second vertical pathway into the transfer space.

4. The elevator system of claim 1, wherein the at least one blocker is situated in the transfer space.

5. The elevator system of claim 1, wherein the at least one blocker is situated on the elevator car.

6. The elevator system of claim 1, comprising
a control associated with the at least one blocker,
the control being configured to cause the at least one blocker to be in the passage condition based on the control determining that the transfer space is configured to receive the elevator car from the one of the vertical pathways,
the control otherwise causing the at least one blocker to be in the blocking condition.

7. The elevator system of claim 6, comprising a carriage in the transfer space, the carriage being configured to receive the elevator car and to effect horizontal movement of the elevator car within the transfer space and wherein
the control determines that the transfer space is configured to receive the elevator car from the first vertical pathway when the carriage is aligned with the first vertical pathway; and
the control determines that the transfer space is configured to receive the elevator car from the second vertical pathway when the carriage is aligned with the second vertical pathway.

8. The elevator system of claim 7, comprising at least one detector that provides an indication of whether the carriage is aligned with one of the vertical pathways, and
wherein the control determines whether the at least one blocker should be in the blocking or passage condition based on the indication from the at least one detector.

9. The elevator system of claim 7, wherein the control is configured to cause the carriage to move within the transfer space.

10. The elevator system of claim 1, comprising
a carriage in the transfer space, the carriage being configured to receive the elevator car and to effect movement of the elevator car within the transfer space; and
wherein
the carriage is moveable in the transfer space between a first position aligned with the first vertical pathway and a second position aligned with the second vertical pathway;
the transfer space is configured to receive the elevator car from the first vertical pathway when the carriage is in the first position; and
the transfer space is configured to receive the elevator car from the second vertical pathway when the carriage is in the second position.

11. The elevator system of claim 10, wherein
the carriage includes guiding surfaces to guide movement of the elevator car onto the carriage in the transfer space;
each of the vertical pathways has guiding surfaces to guide movement of the elevator car;
the carriage is in the first position when the carriage guiding surfaces are aligned with the guiding surfaces in the first vertical pathway; and
the carriage is in the second position when the carriage guiding surfaces are aligned with the guiding surfaces in the second vertical pathway.

12. The elevator system of claim 10, wherein the carriage interacts with the at least one blocker to cause the at least one blocker to move between the blocking and passage positions.

13. The elevator system of claim 10, wherein the at least one blocker is supported on the carriage.

14. The elevator system of claim 1, wherein the at least one blocker comprises a bumper configured to cushion any impact of the elevator car against the at least one blocker.

15. The elevator system of claim 1, comprising
a control associated with the at least one blocker,
the control being configured to cause the at least one blocker to be in the blocking condition based on the control determining that the transfer space is not configured to receive the elevator car from the one of the vertical pathways,
the control otherwise causing the at least one blocker to be in the passage condition.

16. The elevator system of claim 1, wherein
the at least one blocker is in the passage condition to allow movement of the elevator car from the transfer space into the one of the vertical pathways; and
the at least one blocker is in the blocking condition to prevent the elevator car from moving from the transfer space when the transfer space into the one of the vertical pathways.

17. A method of controlling movement of an elevator car in an elevator system that includes a plurality of vertical pathways and a transfer space, the method comprising:
moving the elevator car within one of the vertical pathways toward the transfer space; and
controlling at least one blocker to be
in a passage condition allowing the elevator car to move from the one of the vertical pathways into the transfer space when the transfer space is configured to receive the elevator car from the one of the vertical pathways, or
in a blocking condition preventing the elevator car from moving from the one of the vertical pathways into the transfer space when the transfer space is not configured to receive the elevator car from the one of the vertical pathways.

18. The method of claim 17, wherein
the elevator system includes a carriage configured to receive the elevator car and to effect horizontal movement of the elevator car within the transfer space; and
the method comprises
selectively moving the carriage horizontally in the transfer space between a first position for receiving the elevator car from the first one of the vertical pathways and a second position for receiving the elevator car from a second one of the vertical pathways.

19. The method of claim 18, wherein
the carriage includes guiding surfaces to guide movement of the elevator car onto the carriage in the transfer space;
each of the vertical pathways has guiding surfaces to guide movement of the elevator car;
the carriage is in the first position when the carriage guiding surfaces are aligned with the guiding surfaces in the first one of the vertical pathways; and
the carriage is in the second position when the carriage guiding surfaces are aligned with the guiding surfaces in the second one of the vertical pathways.

20. The method of claim 17, comprising
using a control to cause the at least one blocker to be in the passage condition with respect to the one of the vertical pathways based on the control determining that the transfer space is configured to receive the elevator car from the one of the vertical pathways, and
otherwise using the control to cause the at least one blocker to be in the blocking condition with respect to the one of the vertical pathways.
